(19) United States
(12) Patent Application Publication
(10) Pub. No.: US 2025/0265873 A1
(43) Pub. Date: Aug. 21, 2025

(54) DETERMINING DEVICE, STORAGE MEDIUM STORING COMPUTER PROGRAM FOR DETERMINATION, AND DETERMINING METHOD

(71) Applicant: TOYOTA JIDOSHA KABUSHIKI KAISHA, Toyota-shi Aichi-ken (JP)

(72) Inventor: Noboru Tanase, Machida-shi Tokyo-to (JP)

(73) Assignee: TOYOTA JIDOSHA KABUSHIKI KAISHA, Toyota-shi Aichi-ken (JP)

(21) Appl. No.: 19/043,577

(22) Filed: Feb. 3, 2025

(30) Foreign Application Priority Data
Feb. 21, 2024 (JP) 2024-024492

(51) Int. Cl. G07C 5/08; G01P 3/00; G06T 7/20; G06T 7/70

(52) U.S. Cl. CPC G07C 5/0808; G01P 3/00; G06T 7/20; G06T 7/70; G06T 2207/30252

(57) ABSTRACT

A determining device has a processor configured to detect a first roll angle by which a vehicle has rotated around a front-rear axis of the vehicle as a center, based on an image representing surrounding environment of the vehicle, to set a rollover determination scale based on the detected first roll angle, and to determine whether or not the vehicle has rolled over, using the rollover determination scale, based on a roll angular velocity representing the rotational speed around the front-rear axis of the vehicle and a second roll angle calculated by integrating the roll angular velocity.

### CROSS-REFERENCE TO RELATED APPLICATIONS

This application claims priority to Japanese Patent Application No. 2024-024492 filed Feb. 21, 2024, the entire contents of which are herein incorporated by reference.

### FIELD

The present disclosure relates to a determining device, a storage medium storing a computer program for determination, and a determining method.

### BACKGROUND

A vehicle may be equipped with a determining device that determines when the vehicle rolls over. Such a determining device detects the roll angular velocity using a roll angular velocity sensor that indicates the rotational speed around the front-rear axis of the vehicle, and determines whether or not the vehicle has rolled over based on the roll angular velocity and the roll angle obtained by integrating the roll angular velocity.

When the determining device determines that the vehicle has rolled over, an airbag is deployed to cover the side of the head of the driver in order to protect the driver.

The roll angle is determined by integrating the roll angular velocity, with zero as the initial value when the vehicle has started. Therefore, in cases where the vehicle has stopped on the road with an inclination in the lateral direction at the time the vehicle has started, it has not been possible to calculate the correct roll angle.

Japanese Unexamined Patent Publication No. 2004-268699 proposes correcting the roll angular velocity-integrated roll angle by the tilt angle detected using a tilt sensor, and determining rollover based on the corrected roll angle.

### SUMMARY

However, since tilt sensors are not normally installed in vehicles, newly installing a tilt sensor in a vehicle increases production cost for the vehicle.

It is an object of the present disclosure to provide a determining device that can accurately determine rollover of a vehicle without increasing production cost for the vehicle.

(1) According to one embodiment, the present disclosure provides a determining device. The determining device has a processor configured to detect a first roll angle by which a vehicle has rotated around a front-rear axis of the vehicle as a center, based on an image representing surrounding environment of the vehicle, set a rollover determination scale based on the first roll angle, and determine whether or not the vehicle has rolled over, using the rollover determination scale, based on a roll angular velocity representing a rotational speed around the front-rear axis of the vehicle and a second roll angle calculated by integrating the roll angular velocity.

(2) In the determining device of (1), the processor is further configured to set the rollover determination scale based on the first roll angle detected while the vehicle is traveling.

(3) In the determining device of embodiment (1) or (2), the rollover determination scale is represented as a rollover region in a coordinate plane in which a first axis represents a roll angle and a second axis represents a roll angular velocity, the roll angle and the roll angular velocity being equal to or greater than predetermined reference values, and the processor is further configured to set the rollover determination scale by moving the rollover region in the direction of the first axis from a reference position by an amount of the detected first roll angle.

(4) In the determining device of any one of embodiments (1) to (3), the processor is further configured to determine whether or not the detected first roll angle exceeds a predetermined reference roll angle, and halt determination of whether or not the vehicle has rolled over when it has been determined that the first roll angle exceeds the reference roll angle.

(5) In the determining device of embodiment (4), the processor is further configured to use a smaller reference roll angle when the vehicle is being manually driven than when the vehicle is being self-driven.

(6) According to another embodiment, a storage medium storing a computer program for determination is provided. The computer program for determination includes detecting a first roll angle by which a vehicle has rotated around a front-rear axis of the vehicle as a center, based on an image representing surrounding environment of the vehicle, setting a rollover determination scale based on the first roll angle, and determining whether or not the vehicle has rolled over, using the rollover determination scale, based on a roll angular velocity representing a rotational speed around the front-rear axis of the vehicle and a second roll angle calculated by integrating the roll angular velocity.

(7) According to yet another embodiment of the present disclosure, a determining method is provided. The determining method includes detecting a first roll angle by which a vehicle has rotated around a front-rear axis of the vehicle as a center, based on an image representing surrounding environment of the vehicle, setting a rollover determination scale based on the first roll angle, and determining whether or not the vehicle has rolled over, using the rollover determination scale, based on a roll angular velocity representing a rotational speed around the front-rear axis of the vehicle and a second roll angle calculated by integrating the roll angular velocity.

The determining device of the disclosure can accurately determine rollover of a vehicle without increasing production cost for the vehicle.

The object and advantages of the present disclosure will be realized and attained by the elements and combinations particularly specified in the claims. It is to be understood that both the foregoing general description and the following detailed description are exemplary and explanatory and are not restrictive of the present disclosure, as claimed.

### BRIEF DESCRIPTION OF DRAWINGS

FIG. 1 is a diagram illustrating operation of a determining device of the embodiment in overview.

FIG. 2 is a hardware configuration diagram for a vehicle in which the determining device of the embodiment is mounted.

FIG. 3 is an example of an operation flow chart for setting processing for a determining device according to the embodiment.

FIG. 4 is a diagram illustrating a rollover determination scale.

FIG. 5 is an example of an operation flow chart for determination processing by a determining device according to the embodiment.

FIG. 6 is an example of an operation flow chart showing a modified example of determination processing by a modified example of a determining device according to the embodiment.

### DESCRIPTION OF EMBODIMENTS

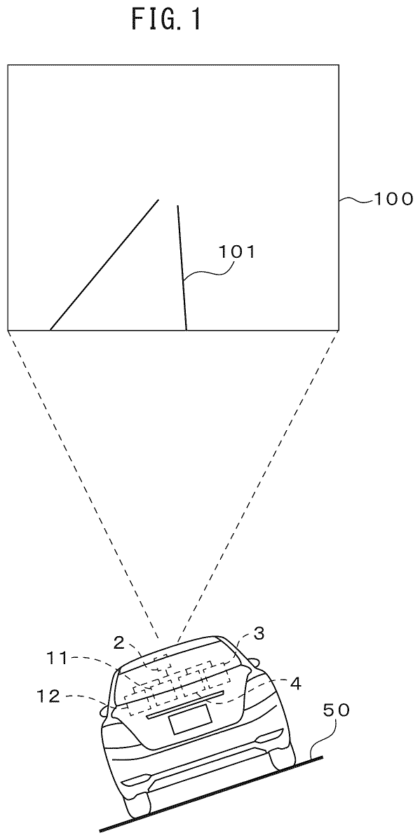

FIG. 1 is a diagram illustrating operation of a determining device of the embodiment in overview. Operation relating to determination processing by the determining device 12 disclosed herein will now be described in overview with reference to FIG. 1.

A vehicle 10 is on a road 50 which is inclined with respect to the horizontal, in the direction perpendicular to the traveling direction of the vehicle 10. The vehicle 10 is therefore in a state of rotation around the front-rear direction of the vehicle 10 as the center, as compared to being on a horizontal road.

The vehicle 10 has a camera 2, an angular velocity sensor 3, an airbag device 4, an automatic control device 11 and a determining device 12. The airbag device 4 is mounted on the top of the door of the driving seat of the vehicle 10. When the vehicle 10 has rolled over, the airbag device 4 deploys the airbag so as to cover the side of the head of the driver, thus alleviating impact onto the head.

The camera 2 acquires camera images representing the environment in the region ahead of the vehicle 10. The automatic control device 11 controls operation of the vehicle 10 based on camera images acquired by the camera 2, etc. The vehicle 10 may also be a self-driving vehicle.

The determining device 12 determines whether or not the vehicle 10 has rolled over using a predetermined rollover determination scale, based on the roll angular velocity representing the rotational speed around the front-rear axis of the vehicle 10, and the roll angle calculated by integrating the roll angular velocity. When it has determined that the vehicle 10 has rolled over, the determining device 12 deploys the airbag of the airbag device 4.

The road 101 on which the vehicle 10 is traveling is represented in the camera image 100 acquired by the camera 2. The road 101 is shown to be inclined from the horizontal in the camera image 100.

Based on the camera image, the determining device 12 detects a roll correction angle around the front-rear axis of the vehicle 10 as the center. The roll correction angle represents the angle the vehicle 10 has rotated around the front-rear axis of the vehicle 10 as the center (the roll angle), compared to when the vehicle 10 is on a horizontal road. Since the vehicle 10 is on an inclined road in the example shown in FIG. 1, the determining device 12 detects a non-zero roll correction angle.

The determining device 12 sets the rollover determination scale based on the roll correction angle. By setting the rollover determination scale based on the roll correction angle, the assessment scale for the roll angle is corrected by the degree of the roll angle corresponding to the inclination of the road on which the vehicle 10 is located. The determining device 12 uses the set rollover determination scale to determine whether or not the vehicle 10 has rolled over.

The camera image is used as information to control the vehicle 10 by the automatic control device 11. The determining device 12 uses the camera 2 already mounted on the vehicle 10 to carry out accurate rollover determination.

As explained above, the determining device 12 can accurately determine rollover of the vehicle 10 without increasing production cost for the vehicle 10.

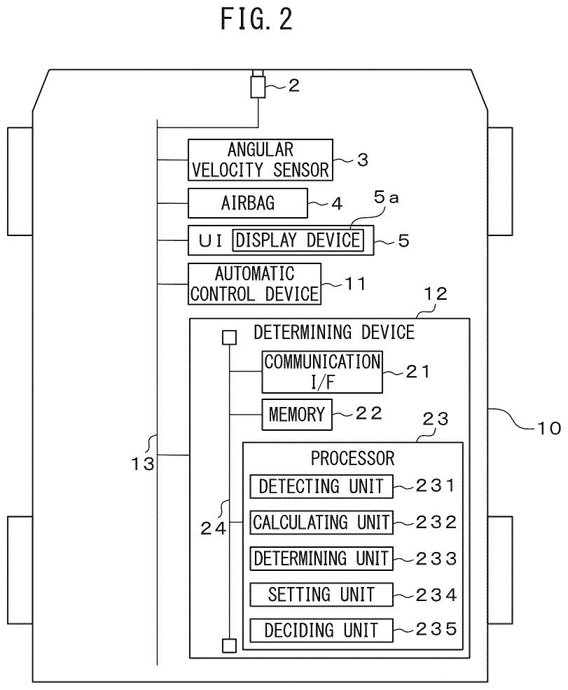

FIG. 2 is a hardware configuration diagram for the vehicle 10 in which the determining device 12 of the embodiment is mounted. The vehicle 10 has a camera 2, an angular velocity sensor 3, an airbag device 4, a user interface (UI) 5, an automatic control device 11 and a determining device 12. The vehicle 10 may also have a LiDAR sensor, as a distance sensor (not shown) for measurement of the distance of the vehicle 10 to surrounding objects.

The camera 2, angular velocity sensor 3, airbag device 4, UI 5, automatic control device 11 and determining device 12 are connected in a communicable manner via an in-vehicle network 13 conforming to the Controller Area Network standard.

The camera 2 is mounted inside the vehicle 10 and directed toward the front of the vehicle 10. For accurate detection of the roll correction angle, in some embodiments, the camera 2 is attached with the optical axis oriented parallel to the front-rear axis of the vehicle 10.

The camera 2, for example, acquires a camera image in which the environment of a predetermined region ahead of the vehicle 10 is shown, at a predetermined cycle. The camera image can show the road in the predetermined region ahead of the vehicle 10, and road features such as surface lane marking lines on the road. The camera image may also include other vehicles which are located ahead of the vehicle 10. The camera 2 has a 2D detector composed of an array of photoelectric conversion elements with visible light sensitivity, such as a CCD or C-MOS, and an imaging optical system that forms an image of the photographed region on the 2D detector. The camera image is an example of an image representing the environment surrounding the vehicle 10. Camera images may be acquired in a cycle of 0.1 seconds to 0.5 seconds, for example.

Each time a camera image is acquired, the camera 2 outputs the camera image and the camera image acquisition time at which the camera image was acquired, through the in-vehicle network 13 to the automatic control device 11 and determining device 12, etc. At the automatic control device 11, the camera image is used for processing to detect objects surrounding the vehicle 10. The camera image is used for rollover determination scale setting processing by the determining device 12. The vehicle 10 may also have another camera mounted in the vehicle 10 and directed toward the rear of the vehicle 10.

The angular velocity sensor 3 detects the roll angular velocity representing the

rotational speed around the front-rear axis of the vehicle 10, and outputs information representing the roll angular velocity to the automatic control device 11 and determining device 12, etc. via the in-vehicle network 13. The angular velocity sensor 3 may use a piezoelectric or electrical capacitance-type sensor. The reference used for the front-rear axis of the vehicle 10 may be a line connecting the roll centers of the front and rear suspensions of the vehicle 10, for example. The automatic control device 11 acquires the roll angular velocity of the vehicle 10 and controls the vehicle 10, based on the information representing the roll angular velocity. The determining device 12 acquires the roll angular velocity of the vehicle 10 and carries out rollover determination scale setting processing, based on the information representing the roll angular velocity.

When the vehicle 10 rolls over, the airbag device 4 deploys an airbag to protect the side of the head of the driver. The airbag device 4 is controlled by the determining device 12. When a deploy signal is input from the determining device 12, the airbag device 4 sends a current to a squib disposed inside the airbag, the heat generated by the squib causing ignition of an adjacent detonator. Gas is generated in the airbag by a chemical reaction using the explosive heat of the detonator, causing the airbag to inflate. Airbag devices may also be disposed on tops of the doors of the passenger seat and back seats. An airbag device may also be situated to protect the front of the driver.

The UI 5, controlled by the automatic control device 11 and determining device 12, notifies the driver of the vehicle 10 traveling information and warnings, etc. The vehicle 10 traveling information includes the current location of the vehicle 10, and notifications to the driver. The UI 5 has a display device 5a such as a liquid crystal display or touch panel, for display of the traveling information. The UI 5 may also have an acoustic output device (not shown) to notify the driver of traveling information.

The UI 5 also creates an operation signal in response to operation of the vehicle 10 by the driver. The UI 5 also has a touch panel or operating button, for example, as an input device for inputting operation information from the driver to the vehicle 10. The operation information may be, for example, a destination location, transit points, vehicle speed and a control transfer request. The control transfer request is made for transfer of control of the vehicle 10 from self-driving mode to manual driving mode, or from manual driving mode to self-driving mode. The UI 5 outputs the input operation information to the automatic control device 11 or determining device 12, etc. via the in-vehicle network 13.

The automatic control device 11 controls operation including traveling of the vehicle 10. The automatic control device 11 has two driving modes with different degrees of participation of the driver for driving. The automatic control device 11 controls the operation of the vehicle 10 according to the driving mode.

For example, the automatic control device 11 has a self-driving mode in which the degree to which the driver participates in driving is low (for example, driving mode with levels 3 to 5) and a manual driving mode in which the degree to which the driver participates in driving is high (for example, driving mode with levels 0 to 2). In self-driving mode, the vehicle 10 is driven primarily by the automatic control device 11. In manual driving mode, the vehicle 10 is driven primarily by the driver.

In the driving mode in which the degree to which the driver participates in driving is low, all or some of the driving operations necessary for traveling of the vehicle 10 are executed automatically, while in the driving mode in which the degree to which the driver participates in driving is high, the types of driving operations executed automatically are less than in the driving mode in which the degree to which the driver participates in driving is low, or are zero.

In self-driving mode, the automatic control device 11 generates a driving plan to control actions such as steering, engine actuation and braking based on map information and on detection information from sensors (not shown) mounted in the vehicle 10. The automatic control device 11 outputs the automatic control signal based on the driving plan, to an actuator (not shown) that controls the steering wheel, a drive unit (not shown), or the brake (not shown), via the in-vehicle network 13.

In manual driving mode, the automatic control device 11 generates a manual control signal to control operation of the vehicle 10 such as steering, actuation and braking based on operation by the driver, and outputs the manual control signal to an actuator for actuation of the steering wheel, and to a drive unit or brake, via the in-vehicle network 13.

The automatic control device 11 outputs mode information representing the current driving mode to the determining device 12, via the in-vehicle network 13.

The automatic control device 11 can drive the vehicle 10 in self-driving mode in regions where self-driving mode is permitted (for example, regions where a high-precision map has been prepared for control of the vehicle 10). In regions where self-driving mode is not permitted, the automatic control device 11 controls the vehicle 10 in manual driving mode. In response to a request by the driver, the automatic control device 11 switches from self-driving mode to manual driving mode or from manual driving mode to self-driving mode. The automatic control device 11 also switches from self-driving mode to manual driving mode when it has determined that the vehicle 10 cannot be safely driven in self-driving mode.

The determining device 12 carries out detection processing, calculation processing, determination processing, setting processing and decision processing. For this purpose, the determining device 12 has a communication interface (IF) 21, a memory 22 and a processor 23. The communication interface 21, memory 22 and processor 23 are connected via signal wires 24. The communication interface 21 has an interface circuit to connect the determining device 12 with the in-vehicle network 13.

The memory 22 is an example of a storage unit, and it has a volatile semiconductor memory and a non-volatile semiconductor memory, for example. The memory 22 stores an application computer program and various data to be used for information processing carried out by the processor 23 of each device.

All or some of the functions of the determining device 12 are functional modules driven by a computer program operating on the processor 23, for example. The processor 23 has a detecting unit 231, a calculating unit 232, a determining unit 233, a setting unit 234 and a deciding unit 235. The processor 23 has one or more CPUs (Central Processing Units) and their peripheral circuits. The processor 23 may also have other computing circuits such as a logical operation unit, numerical calculation unit or graphics processing unit. Alternatively, the functional module of the processor 23 may be a specialized computing circuit in the processor 23. The determining device 12 is an electronic control unit (ECU), for example.

The calculating unit 232 inputs information representing the roll angular velocity, integrates the roll angular velocity, and calculates the roll angle. The roll angle calculated by the calculating unit 232 is an example of a second roll angle.

The roll angle may also use the opposite direction from the vertical as 0°. When the vehicle 10 is on a horizontal road, the roll angle is 0°. The roll angle may be represented as 180° clockwise with the opposite direction from the vertical as 0°, or as −180° counterclockwise with the opposite direction from the vertical as 0°. This is merely an example of representing the roll angle, and the roll angle may be represented based on a different reference. The rest of the operation of the determining device 12 is described in detail below.

For FIG. 2, the automatic control device 11 and the determining device 12 were described as separate devices, but all of the devices may also be constructed as a single device.

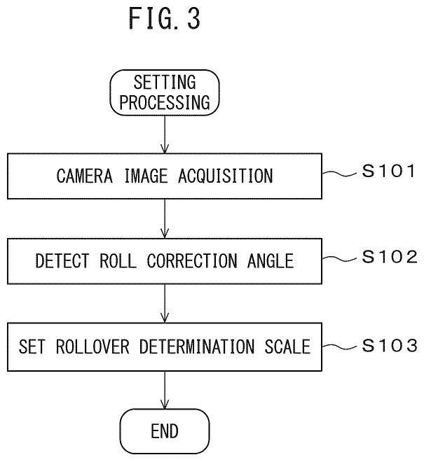

FIG. 3 is an example of an operation flow chart for setting processing by the determining device 12 of this embodiment 12. Setting processing by the determining device 12 will now be explained with reference to FIG. 3. The determining device 12 carries out setting processing according to the operation flow chart shown in FIG. 3, at a setting processing time set with a predetermined cycle. The first setting processing is carried out at a first setting processing time after the vehicle 10 is started. The determining device 12 also carries out setting processing at the setting processing time while the vehicle 10 is traveling.

First, the detecting unit 231 acquires a camera image (step S101). The detecting unit 231 acquires the latest camera image from among multiple camera images output from the camera 2, for example.

Based on the camera image, the detecting unit 231 detects a roll correction angle around the front-rear axis of the vehicle 10 as the center (step S102). The roll correction angle is an example of a first roll angle.

The detecting unit 231 has a classifier trained to classify vehicle roll angles from images. The detecting unit 231 detects the vehicle roll angle by inputting camera images into the classifier. The classifier is trained using images and teacher data labeled with vehicle roll angles when the images have been acquired. The roll angle may be represented as 180° clockwise and −180° counterclockwise, with the opposite direction from the vertical as 0°. In some embodiments, the camera images used for training of the classifier are acquired using a camera having its optical axis mounted in a parallel orientation with respect to the front-rear axis of the vehicle 10, similar to the camera 2. In some embodiments, when the camera images input to the classifier are images of the front of the vehicle 10, the images used for training of the classifier are also images of the front of the vehicle.

The detecting unit 231 may also use a different method for detection of the roll correction angle of the vehicle 10 based on camera images. For example, when the window of a building is shown in the camera image and the upper and lower frames of the window are parallel, it may be the case that a window in front of the camera is visible in the camera image. The upper and lower frames are assumed to be parallel to the ground. Since the inclinations of straight lines representing the upper frame and lower frame in the camera image correspond to the roll angle of the vehicle, the detecting unit 231 can detect the roll angle of the vehicle based on the inclination of the straight line representing the upper frame or lower frame in the camera image.

The detecting unit 231 detects the region representing the window in the camera image

and determines whether or not the upper and lower frames are parallel. The region representing the window frame in the camera image is detected using a machine learned classifier, for example. When the upper and lower frames are parallel, the detecting unit 231 calculates the roll angle as the arctan between the number of pixels representing the shift of the y-coordinate at both ends of the straight line representing the upper frame or lower frame in the camera image, and the number of pixels in the x-direction representing the length of the straight line.

The detecting unit 231 may also detect a roll correction angle for each of the most recently acquired multiple camera images, and calculate the average of the multiple roll correction angles. For example, the detecting unit 231 may detect a roll correction angle from each of multiple camera images acquired within the most recent 0.5 seconds to 1 second.

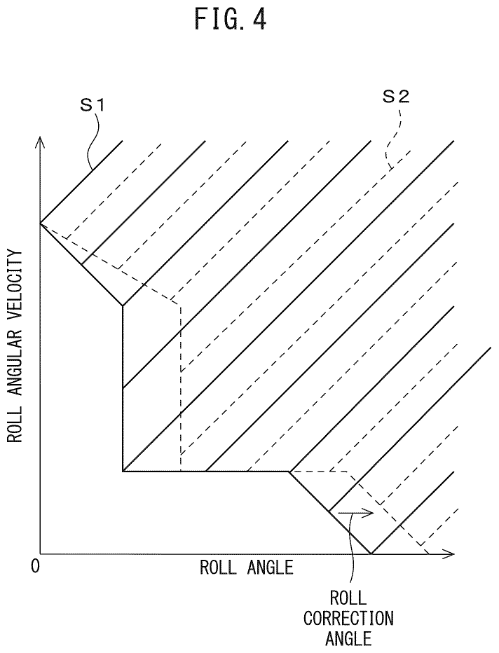

The setting unit 234 then sets a rollover determination scale based on the roll correction angle detected by the detecting unit 231 (step S103), and the series of processing steps is complete. FIG. 4 is a diagram illustrating a rollover determination scale. When the roll correction angle is zero, the rollover determination scale may be represented as a reference rollover region S1 indicating values at or above predetermined reference values for the roll angle and roll angular velocity, in a coordinate plane with the abscissa representing the roll angle and the ordinate representing the roll angular velocity.

Since the detection signal for angular velocity includes a bias, the angular velocity sensor 3 adds an offset component to the roll angle obtained by integration of the roll angular velocity, as time progresses. By setting the rollover determination scale while the vehicle 10 is traveling it is possible to eliminate the effect of the offset component.

The rollover determination scale shown in FIG. 4 is an example in which the roll angle is between 0° and 180°, and the rollover region is located in the first quadrant of the coordinates. When the roll angle is between 0° and −180°, a rollover determination scale is used in which the rollover region is located in the fourth quadrant of the coordinates.

The setting unit 234 moves the reference rollover region S1 in the direction of the abscissa by the amount of the roll correction angle detected by the detecting unit 231. The rollover determination scale after movement is represented as the rollover region S2. When the roll correction angle is zero, the rollover determination scale is represented as the reference rollover region S1.

When the roll angle is between 0° and 180°, the reference rollover region S1 moves in the positive direction on the abscissa. When the roll angle is between 0° and −180°, the reference rollover region S1 moves in the negative direction on the abscissa.

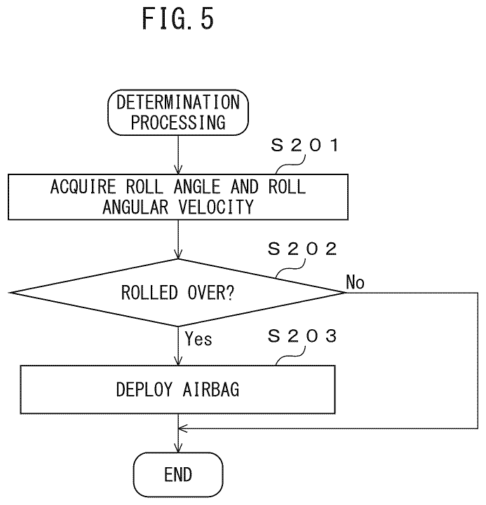

FIG. 5 is an example of an operation flow chart for determination processing by the determining device 12 according to the embodiment. Determination processing by the determining device 12 will now be explained with reference to FIG. 5. The determining device 12 carries out determination processing according to the operation flow chart shown in FIG. 5, at a determining time set with a predetermined cycle. The determining device 12 carries out determination processing at the determining time both when the vehicle 10 is stopped and when it is traveling.

First, the determining unit 233 acquires the roll angle and roll angular velocity (step S201). The determining unit 233 acquires the roll angle which has been calculated by the calculating unit 232. The determining unit 233 also acquires the roll angular velocity based on information representing the roll angular velocity. The determining unit 233 may also use the most recent average roll angular velocity as the current roll angular velocity. The current roll angular velocity may be, for example, the average value for the roll angular velocity within the most recent 0.5 seconds to 1 second. The determining unit 233 is an example of the first determining unit.

The determining unit 233 then determines whether or not the vehicle 10 has rolled over, using the rollover determination scale set by the setting unit 234, based on the roll angular velocity representing the rotational speed around the front-rear axis of the vehicle 10, and the roll angle calculated by integrating the roll angular velocity (step S202). When a point represented by the roll angular velocity and roll angle is included in the rollover region S2, the determining unit 233 determines that the vehicle 10 has rolled over. When a point represented by the roll angular velocity and roll angle is not included in the rollover region S2, on the other hand, the determining unit 233 determines that the vehicle 10 has not rolled over.

When it has determined that the vehicle 10 has rolled over (step S202—Yes), the deciding unit 235 decides to deploy the airbag (step S203), and the series of processing steps is complete. The deciding unit 235 outputs to the airbag device 4 a deploy signal for deployment of the airbag, via the in-vehicle network 13. When a deploy signal is input from the determining device 12, the airbag device 4 deploys the airbag to cover the side of the head of the driver in order to protect the driver.

When it has been determined that the vehicle 10 has not rolled over, on the other hand (step S202—No), the series of processing steps is complete.

As explained above, the determining device can accurately determine rollover of a vehicle without increasing production cost for the vehicle.

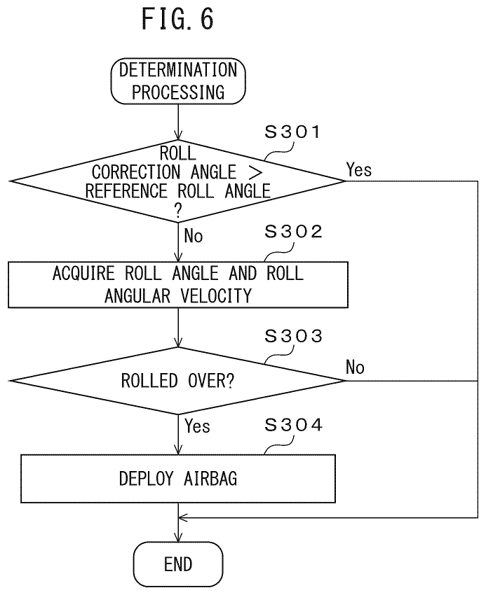

A modified example of the determining device 12 of this embodiment will now be described with reference to FIG. 6. FIG. 6 is an example of an operation flow chart related to determination processing by a modified example of the determining device of the embodiment. This modified example differs from the determination processing shown in FIG. 5 in

that the processing of step S301 is added. The processing in steps S302 to S304 are the same as in steps S201 to S203 described above.

First, the determining unit 233 determines whether or not the roll correction angle detected by the detecting unit 231 exceeds a predetermined reference roll angle (step S301). The determining unit 233 is an example of a second determining unit. The reference roll angle may be 60° to −60°, for example.

When the absolute value of the roll correction angle is greater than 60°, the determining unit 233 determines that the roll correction angle exceeds the reference roll angle. When the absolute value of the roll correction angle is 60° or smaller, on the other hand, the determining unit 233 determines that the roll correction angle does not exceed the reference roll angle.

When the roll correction angle exceeds the reference roll angle (step S301—Yes), the series of processing steps is complete. The roll correction angle exceeding the reference roll angle signifies an unusual value for the inclination of the road. The detecting unit 231 that has detected such a roll correction angle may not be functioning properly. When the vehicle 10 is on such an inclined road, this also constitutes an unusual situation. The determining device 12 therefore halts determination. In this case, the determining unit 233 also notifies the driver via the UI 5 that rollover determination processing for the vehicle 10 is unusual. Because determination is halted, the airbag is not deployed.

When the vehicle 10 is being manually driven, the determining unit 233 may use a smaller reference roll angle than when the vehicle 10 is being self-driven. When the mode information input from the automatic control device 11 indicates manual driving mode, the determining unit 233 determines that the vehicle 10 is being manually driven. When the mode information input from the automatic control device 11 indicates self-driving mode, on the other hand, the determining unit 233 determines that the vehicle 10 is being self-driven.

When the driver is manually driving the vehicle 10, sudden steering operation on an inclined road can potentially result in rollover. The reference roll angle is therefore reduced when the vehicle 10 is being manually driven. The driver may also be warned of rollover by a driver notification indicating that rollover determination processing for the vehicle 10 is unusual.

When the roll correction angle does not exceed the reference roll angle (step S301—No), on the other hand, processing proceeds to step S302.

According to this modified example, the determining device 12 halts rollover determination when the magnitude of the roll correction angle is unusual, thus helping to prevent deployment of the airbag by erroneous determination.

The determining device, computer program for determination and determining method according to the embodiments described in the present disclosure may incorporate appropriate modifications that still fall within the gist of the disclosure. Moreover, the technical scope of the disclosure is not limited to these embodiments, and includes the present disclosure and its equivalents as laid out in the Claims.

For example, setting the rollover determination scale according to the embodiment described above is merely an example, and not to be construed as limiting the method of setting the rollover determination scale. For example, the setting unit may correct the information representing the roll angular velocity output from the roll angular velocity sensor by the degree of the roll correction angle to calculate the corrected roll angular speed. The calculating unit calculates the roll angle by integrating the corrected roll angular speed. The determining unit carries out rollover determination based on the corrected roll angle and the corrected roll angular speed. Setting of the rollover determination scale includes such a method.

When rain or snow is present in the surrounding environment of the vehicle, the setting unit may be configured to not set the rollover determination scale based on the roll correction angle detected by the detecting unit. This is because it may not be possible to detect an accurate roll correction angle based on camera images acquired in a rainy or snowy environment. In such cases the rollover determination scale is represented as the reference rollover region S1.

1. A determining device comprising:
a processor configured to
detect a first roll angle by which a vehicle has rotated around a front-rear axis of the vehicle as a center, based on an image representing surrounding environment of the vehicle,
set a rollover determination scale based on the first roll angle, and
determine whether or not the vehicle has rolled over, using the rollover determination scale, based on a roll angular velocity representing a rotational speed around the front-rear axis of the vehicle and a second roll angle calculated by integrating the roll angular velocity.

2. The determining device according to claim 1, wherein the processor is further configured to set the rollover determination scale based on the first roll angle detected while the vehicle is traveling.

3. The determining device according to claim 1, wherein
the rollover determination scale is represented as a rollover region in a coordinate plane in which a first axis represents a roll angle and a second axis represents a roll angular velocity, the roll angle and the roll angular velocity being equal to or greater than predetermined reference values, and
the processor is further configured to set the rollover determination scale by moving the rollover region in the direction of the first axis from a reference position by an amount of the detected first roll angle.

4. The determining device according to claim 1, wherein the processor is further configured to
determine whether or not the detected first roll angle exceeds a predetermined reference roll angle, and
halt determination of whether or not the vehicle has rolled over when it has been determined that the first roll angle exceeds the reference roll angle.

5. The determining device according to claim 4, wherein the processor is further configured to use a smaller reference roll angle when the vehicle is being manually driven than when the vehicle is being self-driven.

6. A computer-readable, non-transitory storage medium storing a computer program for determination, which causes a processor to execute a process, and the process comprises:
detecting a first roll angle by which a vehicle has rotated around a front-rear axis of the vehicle as a center, based on an image representing surrounding environment of the vehicle;
setting a rollover determination scale based on the first roll angle; and
determining whether or not the vehicle has rolled over, using the rollover determination scale, based on a roll angular velocity representing a rotational speed around the front-rear axis of the vehicle and a second roll angle calculated by integrating the roll angular velocity.

7. A determining method which is carried out by a determining device and the method comprises:
detecting a first roll angle by which a vehicle has rotated around a front-rear axis of the vehicle as a center, based on an image representing surrounding environment of the vehicle;
setting a rollover determination scale based on the first roll angle; and
determining whether or not the vehicle has rolled over, using the rollover determination scale, based on a roll angular velocity representing a rotational speed around the front-rear axis of the vehicle and a second roll angle calculated by integrating the roll angular velocity.
